(19) United States
(12) Patent Application Publication
(10) Pub. No.: US 2010/0253802 A1
(43) Pub. Date: Oct. 7, 2010

(54) ENHANCED MICROSCAN APPARATUS AND METHODS

(75) Inventor: Ernest E. Armstrong, JR., Ravenna, OH (US)

Correspondence Address: GIFFORD, KRASS, SPRINKLE,ANDERSON & CITKOWSKI, P.C, PO BOX 7021, TROY, MI, 48007-7021, US

(73) Assignee: OptiMetrics, Inc.

(21) Appl. No.: 12/752,475

(22) Filed: Apr. 1, 2010

Related U.S. Application Data
(60) Provisional application No. 61/165,973, filed on Apr. 2, 2009.

(51) Int. Cl. H04N 5/228; G06T 17/00

(52) U.S. Cl. 348/222.1; 345/428; 348/E05.031

(57) ABSTRACT

Improved microscan apparatus and methods use a high-resolution optical sensor to measure the displacement of a scene relative to a focal-plane-array (FPA) sensor used to collect images of the scene, eliminating components within the FPA sensor itself to vary the image's location on the FPA. The projection of the scene image varies on the FPA due to the relative movement of the sensor or other external factors. The focal-plane-array (FLA) sensor and high-resolution optical sensor are mounted on a common platform so that both sensors track a scene along the same line of sight. The displacement of a scene on the FPA sensor is computed using the displacement of the scene gathered by the high-resolution optical sensor; and the resolution of the scene on the FPA sensor is enhanced using the computed displacement to generate an output image. The image may be a three-dimensional image, including a 3-D Laser Detection and Ranging (LADAR) image.

### REFERENCE TO RELATED APPLICATION

This application claims priority from U.S. Provisional Patent Application Ser. No. 61/165,973, filed Apr. 2, 2009, the entire content of which is incorporated herein by reference.

### GOVERNMENT SUPPORT

This invention was made with government support under Contract No. FA8650-04-D-1712 awarded by USAF Research Laboratory. The government has certain rights in the invention.

### FIELD OF THE INVENTION

This invention relates generally to image enhancement and, in particular, to apparatus and methods for measuring the displacement of a scene relative to a focal-plane-array (FPA) sensor used to collect images of the scene. As such, there are no components within the FPA sensor itself to vary the image's location on the FPA.

### BACKGROUND OF THE INVENTION

Microscan is a well-known technique to improve the resolution of images obtained using low-resolution (under-sampled) focal-plane array (FPA) sensors.

Traditional microscan techniques involve acquiring and processing multiple frames of data where the scene image has been moved (dithered) by predetermined amounts from a central (reference) location. In the traditional approach, the amount of dither is measured based on a physical property related to the movement of the FPA or of the image with-respect-to the FPA. For example, a piezoelectric actuator may be used to move the focal plane array by a measured amount, or the lens may be moved by a small amount, which results in the movement of the image with-respect-to the FPA.

In both of these cases, a physical component of the sensor moves, resulting in the displacement of the image with respect to the FPA. The micro-scan enhancement process requires the processing of multiple images where for each image the displacement of the image with-respect-to the FPA is known from the use of a controlled or measured quantity within the sensor.

### SUMMARY OF THE INVENTION

This invention improves upon microscan techniques through the use of a high-resolution optical sensor to measure the displacement of a scene relative to a focal-plane-array (FPA) sensor used to collect images of the scene. As such, there are no components within the FPA sensor itself to vary the image's location on the FPA. Instead, the projection of the scene image varies on the FPA due to the relative movement of the sensor or other external factors.

The focal-plane-array (FLA) sensor and high-resolution optical sensor are mounted on a common platform so that both sensors track a scene along the same line of sight. The displacement of the scene on the FPA sensor is computed using the displacement of the scene image gathered by the high-resolution optical sensor; and the resolution of the scene on the FPA sensor is enhanced using the computed displacement to generate an output image. The FPA sensor and the high-resolution optical sensor may operate in the same or different optical wave bands.

According to preferred embodiments, the resolution of the scene on the FPA sensor is enhanced using microscanning techniques. The high-resolution optical sensor may form part of a camera. A series of FPA frames may be processed in conjunction with their associated displacements to enhance the resolution of the output image. The images of the scene may be acquired by scanning both sensors in a controlled fashion across the scene, or in the presence of jitter or other random movements of the platform as would be the case in the presence of turbulence beam steering or other atmospheric effects.

The images of the scene may be acquired by both sensors simultaneously, or at different times, in which case the displacement of the scene image gathered by the high-resolution optical sensor may be used to mathematically estimate the displacement of the scene on the FPA sensor. The image may be a three-dimensional image, including a 3-D Laser Detection and Ranging (LADAR) image. The high-resolution optical sensor image is overlaid with the resolution-enhanced output image. This technique has been demonstrated with a low-resolution 3-D Laser Detection and Ranging (LADAR) FPA sensor and a high-resolution visible wavelength camera. It is also suitable for other type of low-resolution FPA sensors.

### DETAILED DESCRIPTION OF THE INVENTION

This invention broadly improves upon existing microscan techniques by measuring the displacement of a scene relative to a focal-plane-array (FPA) sensor used to collect images of the scene. As such, there are no components within the FPA sensor itself to vary the image's location on the FPA. Instead, the projection of the scene image varies on the FPA due to the relative movement of the sensor or other external factors.

The amount of displacement of the scene (and hence the scene's image on the FPA) is measured using a high-resolution optical sensor (i.e., a camera), which is mounted on a common platform along with, and parallel to, the line-of-sight of the FPA sensor. The high-resolution camera collects images of the scene at the same time as the FPA sensor images are collected. Mathematical correlation techniques are then used on a sequence of high-resolution frames to determine the scenes' (‘images’) displacements on a frame-by-frame basis.

Since the FPA sensor and the high-resolution camera are mounted together, the displacements of the scenes (images) on the FPA sensor can be determined from the displacement of the high-resolution camera's images. Thus, a series of FPA frames with their associated displacements can be processed, using standard micro-scan techniques to enhance the resolution of the output image.

The movement of the scene image on the FPA may be obtained through various methods according to the invention, including:
1. Scanning of both cameras in a controlled fashion across the scene;
2. Random movement (scanning or jitter) of the cameras resulting from platform motion;
3. Movement of the scene images relative to the focal plane resulting from atmospheric effects (i.e., turbulence beam steering).

Note that the acquisition of the high-resolution image frames may or may not be simultaneous with the acquisition of the FPA frames. If the acquisition of the high-resolution image frames is not simultaneous with the acquisition of the FPA frames, the relative displacements may be determined from the sequence of high-resolution image frames used to mathematically estimate the displacements for the FPA frames.

The invention is useful in a variety of applications, including the resolution enhancement of both the 2-D intensity image component and the 3-D range component of FPA-derived LADAR imagery. In such cases the process provides a resolution-enhanced 3-D scene. The high-resolution optical sensor image may also be overlaid (i.e., ‘fused’) with the resolution-enhanced 3-D scene to create a high-resolution 3-D virtual scene (a ‘point cloud,’ for example). The 3-D virtual scene can then be manipulated using mathematical techniques to create 2-D scene images as would be seen from locations other than the sensors' viewpoint.

I claim:

1. A microscanning system, comprising:
a focal-plane-array (FPA) sensor and a high-resolution optical sensor mounted on a common platform so that both sensors track a scene along the same line of sight; and
a processor operating to generate an output image by computing the displacement of a scene on the FPA sensor using the displacement of the scene gathered by the high-resolution optical sensor and enhance the scene on the FPA sensor using microscanning techniques.

2. The microscanning system of claim 1, wherein the high-resolution optical sensor forms part of a camera.

3. The microscanning system of claim 1, including the step of processing a series of FPA frames with their associated displacements to enhance the resolution of the output image.

4. The microscanning system of claim 1, wherein the images of the scene are acquired by scanning both sensors in a controlled fashion across the scene.

5. The microscanning system of claim 1, wherein the images of the scene are acquired in the presence of jitter or other random movements of the platform.

6. The microscanning system of claim 1, wherein the images of the scene are acquired in the presence of turbulence beam steering or other atmospheric effects.

7. The microscanning system of claim 1, wherein the images of the scene are acquired by both sensors simultaneously.

8. The microscanning system of claim 1, wherein:
the images of the scene are acquired by both sensors at different times; and
the displacement of the scene gathered by the high-resolution optical sensor is used to mathematically estimate the displacement of the FPA sensor.

9. The microscanning system of claim 1, wherein the output image is a Laser Detection and Ranging (LADAR) image.

10. The microscanning system of claim 1, wherein the output image is a three-dimensional image.

11. The microscanning system of claim 1, wherein the high-resolution optical sensor image is overlaid with the resolution-enhanced output image.

12. An improved method of microscanning, comprising the steps of:
mounting a focal-plane-array (FLA) sensor and a high-resolution optical sensor on a common platform so that both sensors track along the same line of sight;
acquiring images of a scene with both sensors;
computing the displacement of the scene on the FPA sensor using the displacement of scene gathered by the high-resolution optical sensor; and
enhancing the resolution of the scene on the FPA sensor using the computed displacement to generate an output image.

13. The method of claim 12, wherein the the resolution of the scene on the FPA sensor is enhanced using microscanning techniques.

14. The method of claim 12, wherein the high-resolution optical sensor forms part of a camera.

15. The method of claim 12, including the step of processing a series of FPA frames with their associated displacements to enhance the resolution of the output image.

16. The method of claim 12, wherein the images of the scene are acquired by scanning both sensors in a controlled fashion across the scene.

17. The method of claim 12, wherein the images of the scene are acquired in the presence of jitter or other random movements of the platform.

18. The method of claim 12, wherein the images of the scene are acquired in the presence of turbulence beam steering or other atmospheric effects.

19. The method of claim 12, wherein the images of the scene are acquired by both sensors simultaneously.

20. The method of claim 12, wherein:
the images of the scene are acquired by both sensors at different times; and
the displacement of the scene gathered by the high-resolution optical sensor is used to mathematically estimate the displacement of the FPA sensor.

21. The method of claim 12, wherein the output image is a Laser Detection and Ranging (LADAR) image.

22. The method of claim 12, wherein the output image is a three-dimensional image.

23. The method of claim 12, wherein the high-resolution optical sensor image is overlaid with the resolution-enhanced output image.
